(19) United States
(12) Patent Application Publication
(10) Pub. No.: US 2021/0263211 A1
(43) Pub. Date: Aug. 26, 2021

(54) LIGHT GUIDE PLATES

(71) Applicant: Hewlett-Packard Development Company, L.P., Spring, TX (US)

(72) Inventors: Kuan-Ting Wu, Taipei City (TW); Super Liao, Taipei City (TW); Hsing-Hung Hsieh, Taipei City (TW); Stephen Rudisill, San Diego, CA (US); Alexey Kabalnov, San Diego, CA (US)

(73) Assignee: Hewlett-Packard Development Company, L.P., Spring, TX (US)

(21) Appl. No.: 17/052,279

(22) PCT Filed: Nov. 14, 2018
(86) PCT No.: PCT/US2018/060910

§ 371 Date: Nov. 2, 2020

(51) Int. Cl. F21V 8/00; B29C 64/124

(52) U.S. Cl. CPC G02B 6/0065; B29L 2011/0075; B29C 64/124; G02B 6/0051

(57) ABSTRACT

The present disclosure relates to light guide plates and methods for three-dimensional printing of light guide plates. In some examples, the method for 3D printing a light guide plate comprises: forming a plate body by depositing a layer of transparent build material on a build platform; based on a 3D object model of the plate body, inkjet printing fusing agent onto at least a portion of the layer of the transparent build material; and irradiating the fusing agent to heat the transparent build material and at least partially bind the portion of the transparent build material. In some examples, light scattering features are formed on the plate body by depositing a layer of transparent build material on the plate body; based on a 3D object model of light scattering features, inkjet printing fusing agent and scattering particles onto selected portions of the layer of transparent build material; and irradiating the fusing agent to heat the transparent build material and at least partially bind the portion of the transparent build material.

### BACKGROUND

Light guide devices are known in the art and are utilized, by way of example, for illumination, backlighting, signage and display purposes. A light guiding device may comprise a light source, for instance, a fluorescent lamp or a plurality of light emitting diodes (LEDs) and a light guide plate. The light guide plate may comprise light-scattering features that disturb the total internal reflection of the light from the light source, such that the light is guided through the light guide plate in a controlled manner and emitted in a substantially perpendicular direction to that of the direction of propagation of light within the transparent guide.

### BRIEF DESCRIPTION OF THE DRAWINGS

FIG. 1 is a schematic view of an example of a 3-dimensional printing system that may be used to perform a 3-dimensional printing method according to an example of the present disclosure;

FIG. 2 is a schematic illustration of the 3-dimensional printing method performed using the printing system of FIG. 1;

FIG. 3 is a schematic view of an example of a light guide plate according to the present disclosure.

The figures depict several examples of the present disclosure. However, it should be understood that the present disclosure is not limited to the examples depicted in the figures.

### DETAILED DESCRIPTION

It is to be understood that this disclosure is not limited to the compositions or methods disclosed herein. It is also to be understood that the terminology used in this disclosure is used for describing particular examples. The terms are not intended to be limiting because the scope of the present disclosure is intended to be limited by the appended claims and equivalents thereof.

It is noted that, as used in this specification and the appended claims, the singular forms “a,” “an,” and “the” include plural referents unless the context clearly dictates otherwise.

As used in the present disclosure, “liquid vehicle” refers to a liquid in which at least one additive may be dissolved or dispersed to form an inkjet composition. A wide variety of liquid vehicles may be used with the compositions and methods of the present disclosure. A variety of different additives, including, surfactants, solvents, co-solvents, anti-kogation agents, buffers, biocides, sequestering agents, viscosity modifiers, and surface-active agents may be dispersed or dissolved in the liquid vehicle.

The term “fusing agent” is used herein to describe agents that may be applied to powder bed material, and which may assist in binding or coalescing the powder bed material to form a layer of a 3D part. Heat may be used to fuse the powder bed material, but the fusing agent can also assist in binding powder together, and/or in generating heat from electromagnetic energy (e.g. infrared and near infrared). For example, the fusing agent may become energized or heated when exposed to a frequency or frequencies of electromagnetic radiation. Any additive that assists in binding or fusing particulate powder bed material to form the 3D printed part can be used.

As used in the present disclosure, “jet,” “jettable,” “jetting,” or the like refers to compositions that are ejected from jetting architecture, such as inkjet architecture. Any suitable inkjet architecture may be used. For example, the inkjet architecture can include thermal or piezo architecture. Additionally, such architecture can be configured to print varying drop sizes, for example, less than about 50 pl, less than about 40 pl, less than about 30 pl, less than about 20 pl, less than about 10 pl. In some examples, the drop size may be about 1 to about 40 pl, for example, about 3 to about 30 pl or about 5 to about 20 picolitres.

As used in the present disclosure, the term “substantial” or “substantially” when used in reference to a quantity or amount of a material, or a specific characteristic thereof, refers to an amount that is sufficient to provide an effect that the material or characteristic was intended to provide. The exact degree of deviation allowable may in some cases depend on the specific context.

As used in the present disclosure, the term “build material” may refer to any suitable particulate build material. For example, the build material may comprise polymer, ceramic or metal particles. The build material may also comprise particles of any shape. For example, the particles may be substantially spherical, substantially ovoid, irregularly shaped and/or elongate in shape. In some examples, the particles of build material may be substantially spherical. In some examples, the particles of the build material may take the form of fibers, for instance, cut from longer strands or threads of material.

As used in the present disclosure, the term “about” is used to provide flexibility to a numerical range endpoint. The degree of flexibility of this term can be dictated by the particular variable and determined based on the associated description herein.

As used in the present disclosure, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting one numerical value. Furthermore, such an interpretation should apply regardless of the breadth of the range or the characteristics being described.

The present disclosure relates to a method for three-dimensional printing a light guide plate. The method comprises:
a. forming a plate body by
   depositing a layer of transparent build material on a build platform; based on
   a 3D object model of the plate body, inkjet printing fusing agent onto at least
   a portion of the layer of the transparent build material; and irradiating the fusing agent to heat the transparent build material and at least partially bind the portion of the transparent build material; and
b. forming light scattering features on the plate body by depositing a layer of transparent build material on the plate body; based on a 3D object model of light scattering features, inkjet printing fusing agent and scattering particles onto selected portions of the layer of transparent build material; and irradiating the fusing agent to heat the transparent build material and at least partially bind the portion of the transparent build material.

The present disclosure also provides a light guide plate obtainable by the method described herein.

Additionally, the present disclosure provides a light guide plate comprising a plate body having light scattering features, wherein the plate body comprises transparent polymer and plasmonic resonance particles. The plasmonic resonance particles may be dispersed in a matrix of the transparent polymer.

In some examples, the light scattering layer comprises surface features comprising raised and/or recessed portions and wherein the light scattering layer also comprises scattering particles incorporated therein.

The present disclosure also provides a display screen, for example, for an electronic device comprising a light guide plate described herein.

In the present disclosure, a light guide plate body is formed by depositing a layer of transparent build material on a build platform; based on a 3D object model of the plate body, inkjet printing fusing agent onto at least a portion of the layer of the transparent build material; and irradiating the fusing agent to heat the transparent build material and at least partially bind the portion of the transparent build material. For example, because the droplet size and print location of the fusing agent can be digitally controlled, a thin and uniform light guide body may be produced.

It has also been found that the scattering particles can be introduced at specific locations within the printed part by inkjet printing. For example, because droplet size and print location can be digitally controlled, inkjet compositions containing the scattering particles can be printed in selected amounts at selected locations over the layer of transparent build material. These selected locations may be controlled, such that specific voxels may be selected for printing. When the build material is bound or coalesced following irradiation of the fusing agent, the scattering particles become incorporated into the layer at the selected locations in selected amounts. Furthermore, because fusing agent can also be inkjet printed in selected amounts at selected locations over the layer of transparent build material with a high level of control, surface features can also be introduced as light scattering features with a high degree of accuracy. As a result, intricate light scattering features can be formed on the light guide plate body. These light scattering features can include surface features (e.g. recessed and/or raised portions) as well as scattering particles incorporated at specific locations on the light guide plate. These features can be reproduced with a high degree of accuracy.

In some examples, the scattering particles may be printed droplet by droplet, wherein each droplet has a volume of less than about 50 pl, for example, less than about 40 pl, less than about 30 pl or less than about 20 pl. In some examples, the scattering particles may be printed at a droplet value of at least about 1 pl, for example, at least about 2 pl or at least about 3 pl. In some examples, the scattering particles may be printed at a droplet volume of about 1 to about 50 pl, for example, about 2 to about 30 pl or about 5 to about 20 pl. This can allow the dopant to be printed, in for example, in patterns (e.g. intricate patterns) throughout the printed part.

In some examples, the fusing agent is inkjet-printed as a liquid inkjet ink composition comprising the fusing agent using a first print nozzle, and wherein the scattering particles are inkjet printed as a liquid inkjet ink composition comprising the scattering particles using a second print nozzle.

In some examples, the light scattering features comprise surface features comprising raised and/or recessed features on an outer surface of the light guide plate and scattering particles incorporated in an outer surface of the light guide plate.

In some examples, the scattering particles are selected from silica, alumina, zirconia, hollow polymer particles and/or titanic.

In some examples, the light guide plate has a maximum thickness of less than 4 mm.

In some examples, the fusing agent comprises a plasmonic resonance absorber that absorbs more than about 80% of radiation at wavelengths of about 800 nm to 4000 nm but absorb less than about 20% of radiation having wavelengths of about 400 nm to 780 nm.

In some examples, the fusing agent comprises plasmonic resonance absorber having the formula (1):

MₘM′Oₙ (1)

wherein M is an alkali metal, m is greater than 0 and less than 1, M′ is any metal, and n is greater than 0 and less than or equal to 4.

M may be lithium (Li), sodium (Na), potassium (K), rubidium (Rb) and/or cesium (Cs).

In some examples, the fusing agent comprises a plasmonic resonance absorber selected from tungsten bronzes, modified iron phosphates, tetraphenyldiamine-based dyes, metal bis(dithiolene) complexes and modified copper pyrophosphates.

In some examples, the light guide plate has a refractive index of about 1.49-about 1.60. The light guide plate may have a maximum thickness of less than about 4 mm.

Build Material

Any suitable build material may be employed in the present disclosure. The build material may comprise particles or powder.

In certain examples, the build material particles can have a variety of shapes, such as substantially spherical particles or irregularly-shaped particles. In some examples, the build material particles can be capable of being formed into 3D printed parts with a resolution of about 10 to about 100 μm, for example about 20 to about 80 μm. As used herein, “resolution” refers to the size of the smallest feature that can be formed on a 3D printed part. The build material particles can form layers from about 10 to about 100 μm thick, allowing the fused layers of the printed part (light guide plate) to have roughly the same thickness. This can provide a resolution in the z-axis direction of about 10 to about 100 μm. The build material particles can also have a sufficiently small particle size and sufficiently regular particle shape to provide about 10 to about 100 μm resolution along the x-axis and y-axis.

In some examples, the particles of the build material can be colorless. For example, the particles of the build material can have a translucent, or transparent appearance. When used, for example, with a colorless fusing composition, such particles can provide a printed part that is substantially transparent.

In some examples, the build material can be selected from the group consisting of polymeric powder, polymeric-ceramic composite powder, and combinations thereof. Another example of a suitable build material may be glass.

Suitable build materials include polymer build materials, including, for example, polycarbonate, polyacrylate, cyclo-olefin polymer and polyethylene terephthalate. Examples of suitable polyacrylate include polymethylmethacrylate, PMMA.

Other examples of polymers suitable for use as the build material particles include polyethylene, polyethylene oxide, polypropylene, polyoxomethylene (i.e., polyacetals), and combinations thereof. Still other examples of suitable build material particles include polystyrene, polyester, polyurethanes, other engineering plastics, and combinations thereof. For example, the build material may be nylon 6 powder, nylon 9 powder, nylon 11 powder, nylon 12 powder, nylon 66 powder, nylon 612 powder, polyethylene powder, thermoplastic polyurethane powder, polypropylene powder, polyester powder, polycarbonate powder, polyether ketone powder, polyacrylate powder, polystyrene powder, or combinations thereof.

It should be noted that the “combinations” of the polymers described herein can include blends, mixtures, block copolymers, random copolymers, alternating copolymers, periodic polymers, and mixtures thereof.

In some examples, the build material may be a polymeric-ceramic composite powder. The “polymeric-ceramic composite” powder can include one or more of the polymers described above in combination with one or more ceramic materials in the form of a composite. The polymeric-ceramic composite can include any weight combination of polymeric material and ceramic material. For example, the polymeric material can be present in an amount of up to about 99 wt % with the balance being ceramic material or the ceramic material can be present in an amount of up to about 99 nm with the balance being polymeric material.

In some examples, the ceramic material can be selected from the group consisting of silica, fused silica, quartz, alumina silicates, magnesia silicates, boriasilicates, and mixtures thereof. Examples of ceramic materials can include metal oxides, inorganic glasses, carbides, nitrides, and borides. Some specific examples can include alumina (Al2O3), Na₂O/CaO/SiO2glass (soda-lime glass), silicon nitride (Si3N4), silicon dioxide (SiO₂), zirconia (ZrO2), titanium dioxide (TiO2), glass frit materials, or combinations thereof. As an example of one suitable combination, about 30 wt % glass may be mixed with about 70 wt % alumina.

The build material may be made up of similarly sized particles or differently sized particles. The term “size” or “particle size,” as used herein, refers to the diameter of a substantially spherical particle, or the average diameter of a non-spherical particle (i.e., the average of multiple diameters across the particle), or the effective diameter of a non-spherical particle (i.e., the diameter of a sphere with the same mass and density as the non-spherical particle). A substantially spherical particle (i.e., spherical or near-spherical) has a sphericity of >about 0.84. Thus, any individual particles having a sphericity of <about 0.84 are considered non-spherical (irregularly shaped).

As used in the present disclosure, “average” with respect to dimensions of particles refers to a volume average unless otherwise specified. Accordingly, “average particle size” refers to a volume average particle size. Additionally, “particle size” refers to the diameter of spherical particles, or to the longest dimension of non-spherical particles. Particle size may be determined by any suitable method, for example, by laser diffraction spectroscopy.

In some examples, the particle size of the build material particles can be from about 10 μm to about 500 μm, or less than about 450 μm, or less than about 400 μm, or less than about 350 μm, or less than about 300 μm, or less than about 250 μm, or less than about 200 μm, or less than about 150 μm, or less than about 150 μm, or less than about 90 μm, or less than about 80 μm, or at least about 10 μm, or at least about 20 μm, or at least about 30 μm, or at least about 40 μm, or at least about 50 μm, or at least about 60 μm, or at least about 70 μm, or at least about 80 μm, or at least about 90 μm, or at least about 100 μm, or at least about 110 μm, or at least about 120 μm, or at least about 130 μm, or at least about 140 μm, or at least about 150 μm, or at least about 160 μm, or at least about 170 μm, or at least about 180 μm, or at least about 190 μm.

The build material particles may have a melting point or softening point ranging from about 50° C. to about 400° C. The build material can have a melting or softening point of at least about 60° C., for example, at least about 70° C., at least about 80° C., at least about 90° C., at least about 100° C., at least about 110° C., at least about 120° C., at least about 130° C., at least about 140° C., at least about 150° C. or at least about 160° C. The melting or softening point may be at most about 350° C., for example, at most about 320° C., at most about 300° C., at most about 280° C., at most about 260° C., at most about 240° C. or at most about 220° C.

In some examples, the melting or softening point may be in the range of about 70° C. to about 350° C. In some examples, the melting or softening point may be in the range of about 80° C. to about 320° C., about 90° C. to about 300° C., about 100° C. to about 280° C., about 110° C. to about 260° C., about 120° C. to about 240° C., about 130° C. to about 220° C., or about 140° C. to about 220° C. In further examples, the polymer can have a melting or softening point from about 150° C. to about 200° C.

Fusing Agent

Any suitable fusing agent may be used. In some examples, the fusing agent imparts little or no colour to the finished product.

The fusing agent can have a temperature boosting capacity. This temperature boosting capacity may be used to increase the temperature of the build material above its melting or softening point. As used herein, “temperature boosting capacity” refers to the ability of a fusing agent to convert infrared (e.g. near-infrared) energy into thermal energy. When fusing agent is applied to the build material (e.g. by inkjet printing), this temperature boosting capacity can be used to increase the temperature of the treated (e.g. printed) portions of the build material over and above the temperature of the untreated (e.g. unprinted) portions of the build material. The particles of the build material can be at least partially bound or coalesced when the temperature increases to or above the melting point of the polymer.

As used herein, “melting point” refers to the temperature at which a polymer transitions from a crystalline phase to a pliable, amorphous phase. Some materials (e.g. polymers) do not have a single melting point, but rather have a range of temperatures over which the polymers soften. When the fusing agent is selectively applied to at least a portion of the build material layer by inkjet printing, the fusing agent can heat the treated portion to a temperature at or above the melting or softening point, while the untreated portions remain below the melting or softening point. This allows the formation of a solid 3D printed part, while the loose build material can be easily separated from the finished printed part.

In one example, the fusing agent can have a temperature boosting capacity from about 10° C. to about 70° C., for example, about 15° C. to about 60° C. for a polymer with a melting or softening point of from about 100° C. to about 350° C. If the bed of build material (or powder) is at a temperature within about 10° C. to about 70° C. of the melting or softening point, then such a fusing agent can boost the temperature of the printed powder up to the melting or softening point, while the unprinted build material remains at a lower temperature. In some examples, the build material bed can be preheated to a temperature from about 10° C. to about 70° C. lower than the melting or softening point of the polymer. The fusing agent can then be applied (e.g. printed) onto the build material and the build material bed can be irradiated with a near-infrared light to coalesce the treated (e.g. printed) portion of the build material.

In some examples, the fusing agent containing a plasmonic resonance absorber e.g. dispersed in an aqueous or non-aqueous vehicle. The plasmonic resonance absorber may absorb at wavelengths ranging from about 800 nm to about 4000 nm and may be transparent at wavelengths ranging from about 400 nm to about 780 nm. As used herein “absorption” means that at least about 80% of radiation having wavelengths ranging from about 800 nm to about 4000 nm is absorbed. As used herein “transparency” means that about 40% or less, for instance, or about 20% or less (e.g. about 15% or less, or about 10% or less) or of radiation having wavelengths ranging from about 400 nm to about 780 nm is absorbed. This absorption and transparency may allow the fusing agent to absorb enough radiation to fuse the build material in contact therewith while causing the 3D part to be substantially uncolored.

The absorption of the plasmonic resonance absorber may be the result of the plasmonic resonance effects. Electrons associated with the atoms of the plasmonic resonance absorber may be collectively excited by electromagnetic radiation, which may result in collective oscillation of the electrons. The wavelengths required to excite and oscillate these electrons collectively may be dependent on the number of electrons present in the plasmonic resonance absorber particles, which in turn may be dependent on the size of the plasmonic resonance absorber particles. The amount of energy required to collectively oscillate the particle's electrons may be low enough that very small particles (e.g., about 1-100 nm) may absorb electromagnetic radiation with wavelengths several times (e.g., from about 8 to 800 or more times) the size of the particles. The use of these particles allows the fusing agent to be inkjet jettable as well as electromagnetically selective (e.g., having absorption at wavelengths ranging fromabout 800 nm to about 4000 nm and transparency at wavelengths ranging from about 400 nm to about 780 nm).

In an example, the plasmonic resonance absorber may have an average particle diameter ranging from greater than about 0 nm to less than about 220 nm. In another example the plasmonic resonance absorber has an average particle diameter ranging from greater than about 0 nm to about 120 nm. In a still another example, the plasmonic resonance absorber has an average (e.g. mean) particle diameter ranging from about 10 nm to about 200 nm.

The amount of the plasmonic resonance absorber that is present in the fusing agent may range from about 0.5 wt % to about 30 wt %, for example, 1 to 20 wt % based on the total wt % of the fusing agent. In some examples, the amount of the plasmonic resonance absorber present in the fusing agent may range from about 1 wt % up to about 15, or, for example, about 3 to about 10 wt % or about 5 to about 8 wt %. In other examples, the amount of the plasmonic resonance absorber may be present in the fusing agent ranges from greater than about 4 wt % up to about 15 wt %. In some examples, these plasmonic resonance absorber loadings may provide a balance between the fusing agent having jetting reliability and electromagnetic radiation absorbance efficiency.

In an example, the plasmonic resonance absorber may be an inorganic pigment. Suitable plasmonic resonance absorbers are described in WO2017/069778. Examples include lanthanum hexaboride (LaB₆), tungsten bronzes (AₓWO₃), indium tin oxide (In₂O₃:SnO₂, ITO), aluminum zinc oxide (AZO), ruthenium oxide (RuO₂), silver (Ag), gold (Au), platinum (Pt), iron pyroxenes (AₓFe_{y}Si₂O₆ wherein A is Ca or Mg, x=1.5-1.9, and y=0.1-0.5), modified iron phosphates (AₓFe_{y}PO₄), and modified copper pyrophosphates (AₓCu_{y}P₂O₇). Tungsten bronzes may be alkali doped tungsten oxides. Examples of suitable alkali dopants (i.e., A in AₓWO₃) may be cesium, sodium, potassium, or rubidium. In an example, the alkali doped tungsten oxide may be doped in an amount ranging from greater than 0 mol % to about 0.33 mol % based on the total mol % of the alkali doped tungsten oxide. Suitable modified iron phosphates (AₓFe_{y}PO₄) may include copper iron phosphate (A=Cu, x=0.1-0.5, and y=0.5-0.9), magnesium iron phosphate (A=Mg, x=0.1-0.5, and y=0.5-0.9), and zinc iron phosphate (A=Zn, x=0.1-0.5, and y=0.5-0.9). For the modified iron phosphates, it is to be understood that the number of phosphates may change based on the charge balance with the cations. Suitable modified copper pyrophosphates (AₓCu_{y}P₂O₇) include iron copper pyrophosphate (A=Fe, x=0-2, and y=0-2), magnesium copper pyrophosphate (A=Mg, x=0-2, and y=0-2), and zinc copper pyrophosphate (A=Zn, x=0-2, and y=0-2). Combinations of the inorganic pigments may also be used.

Other examples of suitable plasmonic resonance absorbers include metal (e.g. nickel) dithiolene complexes. Suitable examples of such plasmonic resonance absorbers are described, for example, in WO 2018/144032, WO 2018/144033 and WO 2018/194542.

In some examples, the plasmonic resonance absorber may be a metal bis(dithiolene) complex. The metal bis(dithiolene) complex may have the formula:

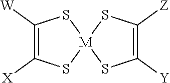

wherein:

M is a metal selected from the group consisting of nickel, zinc, platinum, palladium, and molybdenum; and

each of W, X, Y, and Z is selected from the group consisting of H, Ph, PhR, and SR, wherein Ph is a phenyl group and R is selected from the group consisting of CₙH₂ₙ₊₁, OCₙH₂₊₁, and N(CH₃)₂, wherein 2≤n≤12.

In some examples, M may be nickel.

In some examples, the metal bis(thiolene) complex may be dispersed in a polar aprotic solvent. The polar aprotic solvent may be selected from selected from 1-methyl-2-pyrrolidone, 2-pyrrolidone, 1-(2-hydroxyethyl)-2-pyrrolidone, dimethylformamide (DMF), dimethyl sulfoxide (DMSO), and a combination thereof.

The polar aprotic solvent may be included to at least partially dissolve and reduce the metal bis(dithiolene) complex and to help to shift the absorption of the metal bis(dithiolene) complex.

In some instances, the shift can be further into the near-infrared (NIR) region (e.g., shifting from an absorption maximum of about 850 nm when the metal bis(dithiolene) complex is not reduced to an absorption maximum of about 940 nm when metal bis(dithiolene) complex is reduced (e.g., to its monoanionic form or to its dianionic form). The electron donor compound can shift the absorption maximum of the metal bis(dithiolene) complex by reducing the metal bis(dithiolene) complex to its monoanionic form or to its dianionic form. When the metal bis(dithiolene) complex is reduced to its monoanionic form or to its dianionic form, the color of the metal bis(dithiolene) complex can change. For example, the initial reduction of a nickel bis(dithiolene) complex to its monoanionic form may result in the color changing from green to reddish brown. For example, the further reduction of a nickel bis(dithiolene) complex to its dianionic form may result in the color changing to become substantially colorless. The substantially colorless complex can still absorb infrared radiation.

In some examples, the metal bis(thiolene) complex may be used used in combination with an electron donor compound. The electron donor compound may be the electron donor compound can comprise at least one hindered amine light stabilizer (HALS) compound.

The HALS term is a general term for compounds that can have a 2,2,6,6-tetramethylpiperidine skeleton and are broadly categorized according to molecular weight. An example may be bis(2,2,6,6,-tetramethyl-4-piperidyl)sebacate.

The electron donor compound can facilitate the reduction of the metal bis(dithiolene) complex in combination with a polar aprotic solvent described herein. Without wishing to be bound by theory, the electron donor compound can render the metal bis(dithiolene) complex readily reducible and thus more soluble in the polar aprotic solvent. The reduction of the metal bis(dithiolene) complex to its monoanionic form or to its dianionic form can take place in the absence of the electron donor compound. However, this may require exposure to e.g. elevated temperatures.

In other examples, the plasmonic resonance absorber may be a tetraphenyldiamine-based dye. Such dyes are described in WO 2018/144031. Such dyes may be used in combination with alkyldiphenyloxide disulfonate and 1-methyl-2-pyrrolidone.

In some examples, the plasmonic resonance absorber may comprise at least one nanoparticle comprising: at least one metal oxide. The metal oxide may absorb infrared light in a range of from about 780 nm to about 2300 nm. The metal oxide may have the formula shown in formula (1):

MₘM′Oₙ (1)

wherein M is an alkali metal, m is greater than 0 and less than 1, M′ is any metal, and n is greater than 0 and less than or equal to 4. The nanoparticle may have a diameter of from about 0.1 nm to about 500 nm.

In some examples, the metal oxide can be defined as shown in formula (1) below:

MₘM′Oₙ (1).

M in formula (1) above can be an alkali metal. In some examples, M can be lithium (Li), sodium (Na), potassium (K), rubidium (Rb), cesium (Cs), or mixtures thereof. In some examples, M can be cesium (Cs).

m in formula (1) above can be greater than 0 and less than 1. In some examples, m can be 0.33.

M′ in formula (1) above can be any metal. In some examples, M′ can be tungsten (W), molybdenum (Mb), tantalum (Ta), hafnium (Hf), cerium (Ce), lanthanum (La), or mixtures thereof. In some examples, M′ can be tungsten (W).

n in formula (1) above can be greater than 0 and less than or equal to 4. In some examples, n in formula (1) above can be greater than 0 and less than or equal to 3. The metal oxide can be an IR absorbing inorganic nanoparticle. In some examples, the metal oxide can absorb infrared light in a range of from about 780 nm to about 2300 nm, or from about 790 nm to about 1800 nm, or from about 800 nm to about 1500 nm, or from about 810 nm to about 1200 nm, or from about 820 nm to about 1100 nm, or from about 830 nm to about 1000 nm.

In some examples, the metal oxide nanoparticles can have a diameter of from about 0.01 nm to about 400 nm, or from about 0.1 nm to about 350 nm, or from about 0.5 nm to about 300 nm, or from about 0.7 nm to about 250 nm, or from about 0.8 nm to about 200 nm, or from about 0.9 nm to about 150 nm, or from about 1 nm to about 100 nm, or from about 1 nm to about 90 nm, or from about 1 nm to about 80 nm, or from about 1 nm to about 70 nm, or from about 1 nm to about 60 nm, or from about 2 nm to about 50 nm, or from about 3 nm to about 40 nm, or from about 3 nm to about 30 nm, or from about 3 to about 20 nm, or from about 3 to about 10 nm.

Unless otherwise indicated, by diameter, it is meant mean particle diameter, for example, mean particle diameter by volume or weight (e.g. by volume). The diameter may be determined by any suitable measuring method. Examples include dynamic light scattering techniques and/or SEM methods.

In some examples, in formula (1) shown above, M is cesium (Cs), m is about 0.33, M′ is tungsten (W), and n is greater than 0 and less than or equal to about 3.

The metal oxide nanoparticles present in the fusing agent, have the formula (1) MₘM′Oₙ. In the formula (1), M is an alkali metal. In some examples, M is lithium (Li), sodium (Na), potassium (K), rubidium (Rb), cesium (Cs), or mixtures thereof. In some other examples, M is cesium (Cs). In the formula (1), M′ is any metal. In some examples, M′ is tungsten (W), molybdenum (Mb), tantalum (Ta), hafnium (Hf), cerium (Ce), lanthanum (La), or mixtures thereof. In some other examples, M′ is tungsten (W). In the formula (1), m is greater than 0 and less than about 1. In some examples, m can be about 0.33. In the formula (1), n is greater than 0 and less than or equal to about 4. In some examples, n can be greater than 0 and less than or equal to about 3. In some examples, the nanoparticles of the present disclosure have the formula (1) MmM′On, wherein M is tungsten (W), n is about 3 and M is lithium (Li), sodium (Na), potassium (K), rubidium (Rb), cesium (Cs), or mixtures thereof. The nanoparticles are thus tungsten bronze nanoparticles having the formula MmWO₃.

In some other examples, the metal oxide nanoparticles are cesium tungsten nanoparticles having the formula (1) MmM′On, wherein M is cesium (Cs), m is about 0.33, M′ is tungsten (W), and n is greater than 0 and less than or equal to about 3. In an example, the metal oxide nanoparticle is a cesium tungsten oxide nanoparticles having a general formula of CsxWO₃, where 0<x<1.

The fusing agent composition comprising metal oxide nanoparticles, can also include the zwitterionic stabilizer. The zwitterionic stabilizer may improve the stabilization of the dispersion. While the zwitterionic stabilizer has an overall neutral charge, at least one area of the molecule has a positive charge (e.g., amino groups) and at least one other area of the molecule has a negative charge. The metal oxide nanoparticles may have a slight negative charge. The zwitterionic stabilizer molecules may orient around the slightly negative metal oxide nanoparticles with the positive area of the zwitterionic stabilizer molecules closest to the metal oxide nanoparticles and the negative area of the zwitterionic stabilizer molecules furthest away from the metal oxide nanoparticles. Then the negative charge of the negative area of the zwitterionic stabilizer molecules may repel metal oxide nanoparticles from each other. The zwitterionic stabilizer molecules may form a protective layer around the metal oxide nanoparticles, and prevent them from coming into direct contact with each other and/or increase the distance between the particle surfaces (e.g., by a distance ranging from about 1 nm to about 2 nm). Thus, the zwitterionic stabilizer may prevent the metal oxide nanoparticles from agglomerating and/or settling in the dispersion. Examples of suitable zwitterionic stabilizers include C₂ to C₈ betaines, C₂ to C₈ amino-carboxylic acids having a solubility of at least 10 g in 100 g of water, taurine, and combinations thereof. Examples of the C₂ to C₈ amino-carboxylic acids include beta-alanine, gamma-aminobutyric acid, glycine, and combinations thereof.

The zwitterionic stabilizer may be present, in the fusing agent composition, in an amount ranging from about 2 wt % to about 35 wt % (based on the total wt % of the fusing agent composition). When the zwitterionic stabilizer is the C₂ to C₈ betaine, the C₂ to C₈ betaine may be present in an amount ranging from about 4 wt % to about 35 wt % of a total wt of the fusing agent composition. When the zwitterionic stabilizer is the O₂ to C₈ amino-carboxylic acid, the C₂ to C₈ amino-carboxylic acid may be present in an amount ranging from about 2 wt % to about 20 wt % of a total wt % of the fusing agent composition. When the zwitterionic stabilizer is taurine, taurine may be present in an amount ranging from about 2 wt % to about 35 wt % of a total wt % of the fusing agent composition. The zwitterionic stabilizer may be added to the metal oxide nanoparticles and water before, during, or after milling of the nanoparticles in the water to form the dispersion that would be part of the fusing agent composition.

As discussed above, the fusing agent may comprise plasmonic resonance absorber dispersed in a liquid vehicle. A wide variety of vehicles, including aqueous and non-aqueous vehicles, may be used with the plasmonic resonance absorber. In some instances, the vehicle includes water alone or a non-aqueous solvent (e.g. dimethyl sulfoxide (DMSO), ethanol, etc.) alone. In other instances, the vehicle may further include a dispersing additive, a surfactant, a co-solvent, a biocide, an anti-kogation agent, a silane coupling agent, a chelating agent, and combinations thereof.

Where a dispersing additive is used, the dispersing additive may help to uniformly distribute the plasmonic resonance absorber throughout the fusing agent. The dispersing additive may also aid in the wetting of the fusing agent onto the build material. Some examples of the dispersing additive include a water soluble acrylic acid polymer (e.g., CARBOSPERSE® K7028 available from Lubrizol), a styrene-acrylic pigment dispersion resin (e.g., JONCRYL® 671 available from BASF Corp.), a high molecular weight block copolymer with pigment affinic groups (e.g., DISPERBYK®-190 available BYK Additives and Instruments), and combinations thereof. Whether a single dispersing additive is used or a combination of dispersing additives is used, the total amount of dispersing additive(s) in the fusing agent may range from about 10 wt % to about 200 wt % based on the wt % of the plasmonic resonance absorber in the fusing agent.

Surfactant(s) may also be used in the vehicle to improve the wetting properties of the fusing agent. Examples of suitable surfactants include a self-emulsifiable, nonionic wetting agent based on acetylenic diol chemistry (e.g., SURFYNOL® SEF from Air Products and Chemicals, Inc.), a nonionic fluorosurfactant (e.g., CAPSTONE® fluorosurfactants from DuPont, previously known as ZONYL FSO), and combinations thereof. In other examples, the surfactant is an ethoxylated low-foam wetting agent (e.g., SURFYNOL® 440 or SURFYNOL® CT-111 from Air Products and Chemical Inc.) or an ethoxylated wetting agent and molecular defoamer (e.g., SURFYNOL® 420 from Air Products and Chemical Inc.). Still other suitable surfactants include non-ionic wetting agents and molecular defoamers (e.g., SURFYNOL® 104E from Air Products and Chemical Inc.) or water-soluble, non-ionic surfactants (e.g., TERGITOL™ TMN-6 from The Dow Chemical Company). In some examples, it may be desirable to utilize a surfactant having a hydrophilic-lipophilic balance (HLB) less than 10.

Whether a single surfactant is used or a combination of surfactants is used, the total amount of surfactant(s) in the fusing agent may range from about 0.1 wt % to about 3 wt %, for example, about 0.5 to about 2 wt % based on the total wt % of the fusing agent.

Some examples of the co-solvent that may be added include 1-(2-hydroxyethyl)-2-pyrollidinone, 2-Pyrrolidinone, 1,5-Pentanediol, Triethylene glycol, Tetraethylene glycol, 2-methyl-1,3-propanediol, 1,6-Hexanediol, Tripropylene glycol methyl ether, N-methylpyrrolidone, Ethoxylated Glycerol-1 (LEG-1), and combinations thereof. Whether a single co-solvent is used or a combination of co-solvents is used, the total amount of co-solvent(s) in the fusing agent may range from about 10 wt % to about 80 wt %, for example, about 15 to about 70 weight % or about 20 to about 60 weight % with respect to the total wt % of the fusing agent.

A biocide or antimicrobial may be added to the fusing agent. Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from The Dow Chemical Co.). Whether a single biocide is used or a combination of biocides is used, the total amount of biocide(s) in the fusing agent may range from about 0.1 to about 5 wt %, for example, 0.1 wt % to about 1 wt % with respect to the total wt % of the fusing agent.

An anti-kogation agent may be included in the fusing agent. Kogation refers to the deposit of dried ink (e.g., fusing agent) on a heating element of a thermal inkjet printhead. Anti-kogation agent(s) is/are included to assist in preventing the buildup of kogation. Examples of suitable anti-kogation agents include oleth-3-phosphate (e.g., commercially available as CRODAFOS™ O3A or CRODAFOS™ N-3 acid from Croda), or a combination of oleth-3-phosphate and a low molecular weight (e.g., <5,000) polyacrylic acid polymer (e.g., commercially available as CARBOSPERSE™ K-7028 Polyacrylate from Lubrizol). Whether a single anti-kogation agent is used or a combination of anti-kogation agents is used, the total amount of anti-kogation agent(s) in the fusing agent may range from about 0.1 to about 1 wt %, for example, about 0.1 wt % to about 0.2 wt % based on the total wt % of the fusing agent.

A silane coupling agent may be added to the fusing agent to help bond the organic and inorganic materials. Examples of suitable silane coupling agents include the SILQUEST® A series manufactured by Momentive.

Whether a single silane coupling agent is used or a combination of silane coupling agents is used, the total amount of silane coupling agent(s) in the fusing agent may range from about 0.1 wt % to about 50 wt % based on the wt % of the plasmonic resonance absorber in the fusing agent. In an example, the total amount of silane coupling agent(s) in the fusing agent ranges from about 1 wt % to about 30 wt % based on the wt % of the plasmonic resonance absorber. In another example, the total amount of silane coupling agent(s) in the fusing agent ranges from about 2.5 wt % to about 25 wt %, for example, about 5 to about 15 wt % based on the wt % of the plasmonic resonance absorber.

The fusing agent may also include other additives, such as a chelating agent. Examples of suitable chelating agents include disodium ethylenediaminetetraacetic acid (EDTA-Na) and methylglycinediacetic acid (e.g., TRILON® M from BASF Corp.). Whether a single chelating agent is used or a combination of chelating agents is used, the total amount of chelating agent(s) in the fusing agent may range from about 0 wt % to about 1 wt % based on the total wt % of the fusing agent.

### Scattering Particles

As discussed above, scattering particles may be inkjet printed over the layer of build material to form light scattering features on the light guide plate body.

The scattering particles have a refractive index that allows visible light to be scattered to guide light through the light guide plate.

Suitable scattering particles include particles of alumina, zirconia silica and titania. Other examples of scattering particles include polymeric particles, for example, hollow polymer particles. In one example, hollow particles of styrene acrylic polymer (ROPAQUE™) may be employed. In some examples, the scattering particles may be silica and/or titania.

In some examples, the scattering particles can have a diameter of from about 0.1 nm to about 500 nm, or from about 0.5 nm to about 400 nm, or from about 0.6 nm to about 300 nm, or from about 0.7 nm to about 250 nm, or from about 0.8 nm to about 200 nm, or from about 0.9 nm to about 150 nm, or from about 1 nm to about 100 nm, or from about 1 nm to about 90 nm, or from about 1 nm to about 80 nm, or from about 1 nm to about 70 nm, or from about 1 nm to about 60 nm, or from about 2 nm to about 50 nm, or from about 3 nm to about 40 nm, or from about 4 nm to about 40 nm.

In some examples, the scattering particles can have a diameter of from about 0.1 nm to about 400 nm, or from about 0.3 nm to about 350 nm, or from about 0.5 nm to about 300 nm, or from about 0.7 nm to about 250 nm, or from about 0.8 nm to about 200 nm, or from about 0.9 nm to about 150 nm, or from about 1 nm to about 100 nm, or from about 1 nm to about 90 nm, or from about 1 nm to about 80 nm, or from about 1 nm to about 70 nm, or from about 1 nm to about 60 nm, or from about 2 nm to about 50 nm, or from about 3 nm to about 40 nm, or from about 3 nm to about 30 nm, or from about 3 to about 20 nm, or from about 3 to about 10 nm.

Unless otherwise indicated, by diameter, it is meant mean particle diameter, for example, mean particle diameter by volume or weight. The diameter may be determined by any suitable measuring method. Examples include dynamic light scattering techniques and/or SEM methods.

The scattering particles may be formulated as an ink jet ink composition. The inkjet composition may comprise the scattering particles dispersed in a liquid vehicle. In some examples, the scattering particles can be present in an amount of at least about 0.1 wt %, for example, at least about 0.2 wt %, at least about 0.5 wt %, or at least about 1 wt %. The scattering particles may be present in an amount of at most about 30 wt %, about 20 wt % or 10 wt %, for example, at most about 8 wt %, at most about 6 wt %. In some examples, the scattering particles may be present in an amount of from about 0.5 wt % to about 10 wt % in the inkjet composition. In one example, the scattering particles can be present in an amount from about 1 wt % to about 5 wt %. In another example, the scattering particles can be present in an amount from about 5 wt % to about 10 wt %

In some examples, the inkjet ink composition comprising the scattering particles may also include a binder. A suitable binder may be a polymeric binder. The polymeric binder may be transparent. Suitable transparent binders may include polyacrylic, polyester, and polycarbonate resins. The transparent binders may be present in amounts of about 1 to about 30 wt %, for example, about 3 to about 20 wt % of the total weight of the inkjet ink composition comprising the scattering particles. Suitable amounts may range from about 3 to about 15 weight %, for example, about 5 to about 10 weight %. The binder may be dispersed or dissolved in the inkjet ink composition comprising the scattering particles. During the printing process, when thermal energy is produced by the fusing agent to bind or coalesce the build material, the binder may facilitate the incorporation of any printed scattering particles into the resulting printed part.

In some examples, the inkjet composition comprising the scattering particles may be applied to at least portions of a layer of build (or powder bed) material to form a scattering feature on the printed part. The inkjet composition comprising the scattering particles may be applied to unfused powder bed material. Such an inkjet composition may be applied before or after the application of fusing agent to the build material.

In some examples, the liquid vehicle can include water.

In some examples, an additional co-solvent may also be present. In certain examples, a high boiling point co-solvent can be included. The high boiling point co-solvent can be an organic co-solvent that boils at a temperature higher than the temperature of the powder bed during printing. In some examples, the high boiling point co-solvent can have a boiling point above 250° C. In still further examples, the high boiling point co-solvent can be present at a concentration from about 1 wt % to about 8 wt %, for example, about 2 to 4 wt %.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include, but are not limited to, 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol and 1,5-pentanediol.

A surfactant, or combination of surfactants, can also be present in the inkjet composition comprising the colorant. Examples of surfactants include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the formulation of this disclosure may range from about 0.01 wt % to about 20 wt %. Suitable surfactants can include, but are not limited to, liponic esters such as Tergitol™ 15-S-12, Tergitol™ 15-S-7 available from Dow Chemical Company, LEG-1 and LEG-7; Triton™ X-100; Triton™ X-405 available from Dow Chemical Company; and sodium dodecylsulfate.

Various other additives can be employed to optimize the properties of the inkjet composition comprising the colorant. Examples of these additives are those added to inhibit the growth of harmful microorganisms. These additives may be biocides, fungicides, and other microbial agents, which are routinely used in ink formulations. Examples of suitable microbial agents include, but are not limited to, NUOSEPT® (Nudex, Inc.), UCARCIDE™ (Union carbide Corp.), VANCIDE® (R.T. Vanderbilt Co.), PROXEL® (ICI America), and combinations thereof.

Sequestering agents, such as EDTA (ethylene diamine tetra acetic acid), may be included to eliminate the deleterious effects of heavy metal impurities. Buffers may also be used to control the pH of the composition. Viscosity modifiers may also be present. Such additives can be present at from about 0.01 wt % to about 20 wt %, for example, about 0.1 to about 10 wt %.

### Printing Method

As described above, the present disclosure provides a method for three-dimensional printing a light guide plate. The method comprises depositing a layer of build material on a build platform. The build platform may comprise a supporting platform or may comprise a supporting platform and previously formed layers of the 3-D printed part. Thus, the layer of build (or powder bed) material may be deposited onto the supporting platform to form a first layer of the 3-D printed part, or the layer of build material may be deposited directly onto previously formed layers of the 3-D printed part.

Based on a 3D object model, a fusing agent is then selectively applied onto at least a portion of the layer of the powder bed material. Thereafter, the build material may be irradiated, for instance, with near infrared or infrared radiation. This irradiation may cause the infrared or near infrared absorbing compound of the fusing agent to release thermal energy. This thermal energy may be used to heat the build material to at least partially bind the fusing agent-treated portion of the build material. Thus, process may be repeated layer-by-layer until the light guide plate body is produced.

The light scattering features may then be printed onto the light guide plate body by applying a layer of build material onto the light guide plate body and inkjet printing the scattering particles and fusing agent onto selected regions of the layer of build material according to a 3D object model of the light scattering features. The scattering particles may be inkjet printed at the same or at adjacent locations as the fusing agent. Thus, when the build material is irradiated, for instance, with near infrared or infrared radiation, this irradiation may cause the infrared or near infrared absorbing compound of the fusing agent to release thermal energy. This thermal energy may be used to heat the build material to at least partially bind the fusing agent-treated portion of the build material. As the scattering particles are printed at the same location or adjacent the fusing agent, these particles can thus be incorporated into the 3-D printed part as the build material is bound or coalesced.

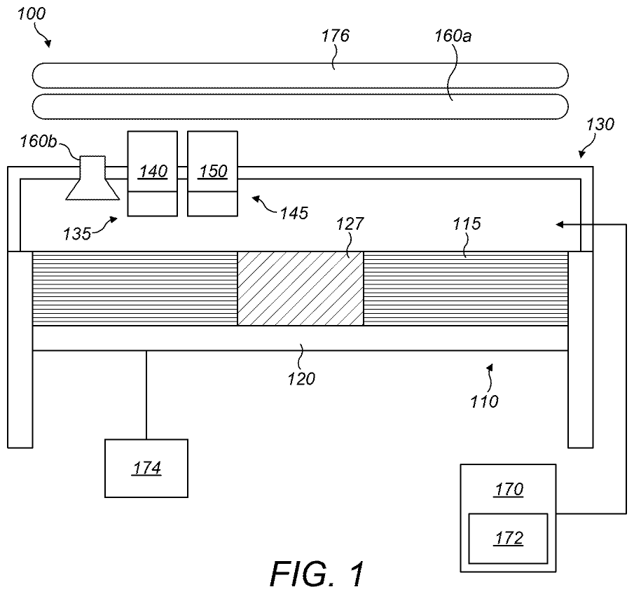

The printing method described herein may be carried out using a 3-dimensional printing system. An example of a 3-dimensional printing system is shown in FIG. 1. The system 100 includes a build material bed or powder bed 110 comprising a build material or powder bed material 115, which includes particles comprising thermoplastic polymer (e.g. polycarbonate, polyacrylate, cyclo-olefin polymer and polyethylene terephthalate). In the example shown, the powder bed material is deposited on a supporting platform or moveable floor 120 that allows the powder bed to be lowered after each layer of the 3-dimensional part is printed. The 3-dimensional part 127 is shown after printing the fusing agent 140 on the powder bed material. The system may also include an ink or fluid jet printer 130 that includes a first ink or fluid jet pen 135 in communication with a reservoir of the fusing agent. The first fluid jet pen can be configured to print the fusing agent onto the powder bed. A second fluid jet pen 145 can be in communication with a reservoir of an inkjet liquid composition 150 comprising scattering particles. The second fluid jet pen can be configured to print the inkjet liquid composition 150 comprising scattering particles (e.g. silica or titanic) onto the powder bed. In some examples, the 3-dimensional printing system can also include additional fluid jet pens in communication with a reservoir of liquid to provide other functionality.

After the fusing agent 140 has been printed onto the powder bed material 115, an infrared or near infrared source, such as a fusing lamp, 160a or 160b can be used to expose the powder bed to radiation sufficient to fuse the powder that has been printed with the fusing agents. Fusing lamp 160a may be a stationary fusing lamp that rests above the powder bed, and fusing lamp 160b may be carried on a carriage with the fluid jet pens 135, 145. To print the next layer, the moveable floor is lowered and a new layer of powder bed material is added above the previous layer. Unused powder bed material, such as that shown at 115, is not used to form the 3-dimensional part, and thus, can be recycled for future use. Recycling can include refreshing the used powder bed material with a relatively small percentage of fresh powder bed material, e.g., as little as up to about 30 wt % (about 1-30 wt %), up to about 20 wt % (about 1-20 wt %), or up to about 10 wt % (about 1-10 wt %).

To achieve good selectivity between the fused and unfused portions of the powder bed material, the fusing agents can absorb enough infrared or near infrared radiation or energy to boost the temperature of the thermoplastic polymer powder above the melting or softening point of the polymer, while unprinted portions of the powder bed material remain below the melting or softening point. Thus, as mentioned, the 3-dimensional printing system can include preheaters for preheating the powder bed material to a temperature near the melting point. In one example, the system can include a preheater(s) to heat the powder bed material prior to printing. For example, the system may include a print bed heater 174 to heat the print bed to a temperature from about 100° C. to about 160° C., or from about 120° C. to about 150° C. The system can further include a supply bed or container 170 which may also include a supply heater 172 at a location where polymer particles are stored before being spread in a layer onto the powder bed 110. The supply bed or container can utilize the supply heater to heat the supply bed or container to a temperature from about 90° C. to about 140° C. Thus, when an overhead heating source 176, e.g., heating lamps, are used to heat up the powder bed material to a printing temperature, the typical minimum increase in temperature for printing can be carried out quickly, e.g., up to about 160° C. to about 220° C. To be clear, the overhead heating source used to heat the powder bed material for printing may be a different energy source than the electromagnetic radiation source, e.g., fusing lamp 160a or 160b, used to thermally activate the energy absorber, though these energy sources could be the same depending on the energy absorber and powder bed material chosen for use.

Suitable fusing lamps for use in the 3-dimensional printing system can include commercially available infrared lamps and halogen lamps. The fusing lamp can be a stationary lamp or a moving lamp. For example, the lamp can be mounted on a track to move horizontally across the powder bed. Such a fusing lamp can make multiple passes over the bed depending on the amount of exposure needed to coalesce each printed layer. The fusing lamp can be configured to irradiate the entire powder bed with a substantially uniform amount of energy. This can selectively coalesce the printed portions with fusing agents leaving the unprinted portions of the powder bed material below the melting or softening point.

In one example, the fusing lamp can be matched with the energy absorbers in the fusing agents so that the fusing lamp emits wavelengths of light that match the peak absorption wavelengths of the energy absorbers. An energy absorber with a narrow peak at a particular infrared or near-infrared wavelength can be used with a fusing lamp that emits a narrow range of wavelengths at approximately the peak wavelength of the energy absorber. Similarly, an energy absorber that absorbs a broad range of near-infrared wavelengths can be used with a fusing lamp that emits a broad range of wavelengths. Matching the energy absorber and the fusing lamp in this way can increase the efficiency of coalescing the polymer particles with the energy absorber printed thereon, while the unprinted polymer particles do not absorb as much light and remain at a lower temperature.

Depending on the amount of energy absorber employed, the absorbance of the energy absorber, the preheat temperature, and the melting or softening point of the thermoplastic polymer, an appropriate amount of irradiation can be supplied from the fusing lamp. In some examples, the fusing lamp can irradiate individual layers from about 0.5 to about 10 seconds per pass, e.g., using one or multiple passes which can depend in part on the speed of a pass or passes.

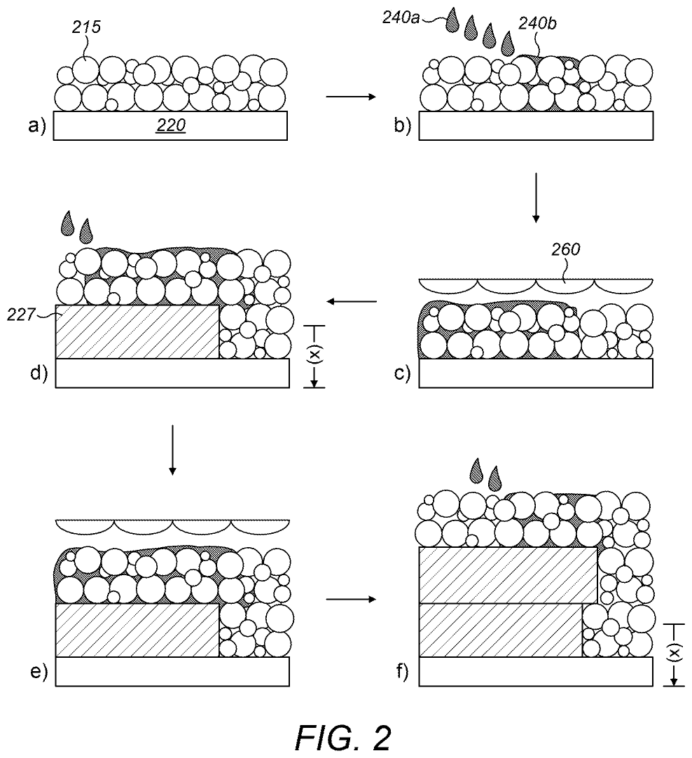

FIG. 2 provides, by way of example, a further schematic illustration of the printing method described with reference to FIG. 1

Turning to FIG. 2 a), this figure shows a build platform or movable floor 220, to which is deposited a thin layer of powder bed material 215. Next, b) shows droplets of a fusing agent 240a as well as already deposited fusing agent 240b applied to and within a portion of the powder bed material. The fusing agent may admix and fill voids within the build material, as shown in c), where the fusing agent and powder bed material are fused to form a fused part layer 227, and the movable floor is moved downward a distance of (x) corresponding to a 3-dimensional fused part layer thickness where the process if repeated, as shown in FIGS. 2 d) to f). In other words, the powder bed material in this example is spread thinly (e.g. about 20μιη to about 120μιη) on the movable floor, combined with fusing agent, fused with electromagnetic energy, the moveable floor dropped, and the process repeated with the prior layer acting as the movable floor for the subsequently applied layer. As can be seen, the second fusible part layer of the “in progress” 3-dimensional part shown at f) is supported by the first fusible part layer as well as by some of the fused powder bed material where the second layer may hang out or cantilever out beyond the first layer. Unfused powder bed material may be collected and reused or recycled. The process depicted in FIGS. 2d) and f) may be repeated until the light guide plate body is formed. Notably, FIG. 2 does not show any of heating mechanisms that may be present, including a heater for the movable floor, a heater for the powder bed material supply, or overhead heaters that likewise may also be present.

Once the light guide plate body is formed, it may be possible to print droplets of an inkjet ink composition comprising scattering particles (not shown) prior to, at the same time as, or after printing droplets of the fusing agent at selected locations and in selected amounts during the printing process. The scattering particles can become incorporated into the printed part in selected amounts at selected locations after fusing. The scattering particles are incorporated as light scattering features over the light guide plate body.

The 3-dimensional part prepared as described herein can be formed of multiple layers of fused polymer stacked in a Z axis direction. The Z axis refers to the axis orthogonal to the x-y plane. For example, in 3-dimensional printing systems having a powder bed floor that lowers after each layer is printed, the Z axis is the direction in which the floor is lowered. The 3-dimensional printed part can have a number of surfaces that are oriented partially in the Z axis direction, such as pyramid shapes, spherical shapes, trapezoidal shapes, non-standard shapes, etc. Thus, virtually any shape that can be designed and which can be self-supporting as a printed part can be crafted.

In further detail, and related to FIGS. 1 and 2, a 3-dimensional printed part can be formed as follows. A fluid or ink jet printer can be used to print a first pass of fusing agent onto a first portion of the powder bed material. There are also other fluid pen(s) that jet ink containing scattering particles onto the powder bed material. This can be done on one pass, two passes, three passes, etc. (back and forth may be considered two passes). If the electromagnetic radiation source is not a bar that sits overhead (which can be left in an on position, or cycled to turn on and off at appropriate times relative to fusing agent application), but rather may be associated with the printing carriage, an irradiation pass can then be performed by passing a fusing lamp over the powder bed to fuse the thermoplastic polymer with the fusing agent. Multiple passes may be used in some examples. Individual passes of printing and irradiating can be followed by further deposit of the powder bed material.

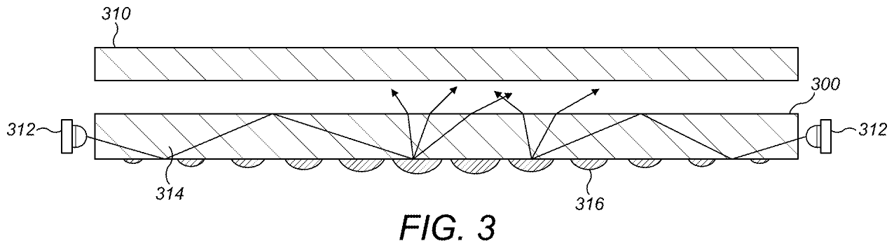

FIG. 3 is a schematic view of a light guide plate 300 according to the present disclosure. Facing the light guide plate 300 is a display screen 310. LEDs 312 are mounted along opposing edges of the light guide plate 300.

The light guide plate 300 comprises a light guide plate body 314 and light scattering features 316 on the light guide plate body 314. The light guide plate body 314 may be formed from a transparent polymer, for example, polycarbonate, polyacrylate, cyclo-olefin polymer and polyethylene terephthalate. Dispersed in the transparent polymer are particles of fusing agent.

The light scattering features 316 may also be formed from transparent polymer, for example, polycarbonate, polyacrylate, cyclo-olefin polymer and polyethylene terephthalate. Fusing agent may also be dispersed in the transparent polymer. Additionally, however, the light scattering features 316 may also comprise light scattering particles dispersed in the transparent polymer.

The light scattering features 316 may take the form of, for example, raised mounds, protrusions or ridges on the surface of the light guide plate body 314.

The light guide plate body 314 may be formed by first depositing a layer of build material (e.g. transparent polymer particles) on a build platform. A fusing agent may then be selectively applied onto at least a portion of the layer of the build material. Thereafter, the build material may be irradiated, for instance, with near infrared or infrared radiation. This irradiation may cause e.g. the infrared or near infrared absorbing compound of the fusing agent to release thermal energy. This thermal energy may be used to heat the build material to at least partially bind the fusing agent-treated portion of the build material. Thus, process may be repeated layer-by-layer until the light guide plate body 314 is produced.

The light scattering features may then be printed onto the light guide plate body 314 by applying a layer of build material onto the light guide plate body and inkjet printing the scattering particles and fusing agent onto selected regions of the layer of build material according to a 3D object model of the light scattering features. The scattering particles may be inkjet-printed at the same or at adjacent locations as the fusing agent. Thus, when the build material is irradiated, for instance, with near infrared or infrared radiation, this irradiation may cause the infrared or near infrared absorbing compound of the fusing agent to release thermal energy. This thermal energy may be used to heat the build material to at least partially bind the fusing agent-treated portion of the build material. As the scattering particles are printed at the same location or adjacent the fusing agent, these particles can thus be incorporated into the 3-D printed part as the build material is bound or coalesced.

When the display unit is in use, light from the LED's 312 is scattered by the light scattering features 316, such that the display screen 310 can be uniformly illuminated.

1. A method for three-dimensional printing a light guide plate, said method comprising:
a. forming a plate body by
depositing a layer of transparent build material on a build platform; based on a 3D object model of the plate body, inkjet printing fusing agent onto at least a portion of the layer of the transparent build material; and
irradiating the fusing agent to heat the transparent build material and at least partially bind the portion of the transparent build material; and
b. forming light scattering features on the plate body by depositing a layer of transparent build material on the plate body; based on a 3D object model of light scattering features, inkjet printing fusing agent and scattering particles onto selected portions of the layer of transparent build material; and irradiating the fusing agent to heat the transparent build material and at least partially bind the portion of the transparent build material.

2. The method as claimed in claim 1, wherein the fusing agent is inkjet-printed as a liquid inkjet ink composition comprising the fusing agent using a first print nozzle, and wherein the scattering particles are inkjet printed as a liquid inkjet ink composition comprising the scattering particles using a second print nozzle.

3. The method as claimed in claim 1, wherein the light scattering features comprise surface features comprising raised and/or recessed features on an outer surface of the light guide plate and scattering particles incorporated in an outer surface of the light guide plate.

4. The method as claimed in claim 3, wherein the scattering particles are selected from silica, alumina, zirconia, hollow polymer particles and/or titania.

5. The method as claimed in claim 1, wherein the light guide plate has a maximum thickness of less than about 4 mm.

6. The method as claimed in claim 1, wherein the fusing agent comprises a plasmonic resonance absorber that absorbs more than about 80% of radiation at wavelengths of about 800 nm to about 4000 nm but absorb less than about 20% of radiation having wavelengths of about 400 nm to about 780 nm.

7. The method as claimed in claim 1, wherein the fusing agent comprises plasmonic resonance absorber having the formula (1):
MₘM′Oₙ (1)
wherein M is an alkali metal, m is greater than 0 and less than 1, M′ is any metal, and n is greater than 0 and less than or equal to 4.

8. The method as claimed in claim 7, wherein M is lithium (Li), sodium (Na), potassium (K), rubidium (Rb) and/or cesium (Cs).

9. The method as claimed in claim 1, wherein the fusing agent comprises a plasmonic resonance absorber selected from tungsten bronzes, modified iron phosphates, tetraphenyldiamine-based dyes, metal bis(dithiolene) complexes and modified copper pyrophosphates.

10. The method as claimed in claim 1, wherein the light guide plate has a refractive index of about 1.49 to about 1.60.

11. A light guide plate comprising a plate body having light scattering features, wherein the plate body comprises transparent polymer and plasmonic resonance particles.

12. The light guide plate as claimed in claim 11, wherein the light scattering layer comprises surface features comprising raised and/or recessed portions and wherein the light scattering layer also comprises scattering particles incorporated therein.

13. The light guide plate as claimed in claim 11, which has a maximum thickness of less than about 4 mm.

14. A light guide plate obtainable by the method of claim 1.

15. A display screen comprising a light guide plate as claimed in claim 11.
